(19) United States
(12) Patent Application Publication
(10) Pub. No.: US 2026/0181082 A1
(43) Pub. Date: Jun. 25, 2026

(54) PROCESSING APPARATUS, PROCESSING SYSTEM, PROCESSING METHOD, AND STORAGE MEDIUM

(71) Applicant: CANON KABUSHIKI KAISHA, Tokyo (JP)

(72) Inventor: TAKASHI HORIKOSHI, Tokyo (JP)

(21) Appl. No.: 19/410,020

(22) Filed: Dec. 5, 2025

(30) Foreign Application Priority Data
Dec. 19, 2024 (JP) 2024-224131

(51) Int. Cl. H04N 1/00

(52) U.S. Cl. CPC H04N 1/00482; H04N 1/00413; H04N 2201/0094

(57) ABSTRACT

To improve usability regarding settings. A processing apparatus receives a first operation for executing specific processing, transmits an instruction to an information terminal to display a setting screen for the specific processing, based on the receipt of the first operation, receives a setting content set on the setting screen from the information terminal, and performs the specific processing using the received setting content.

### BACKGROUND

### Field of the Technology

The present disclosure relates to a processing apparatus, a processing system, a processing method, and a storage medium.

### Description of the Related Art

A processing apparatus is known that performs scanning processing and the like using a preset setting content in response to an instruction from a user. Japanese Patent Laid-Open No. 2013-207691 discloses a technology related to push scanning. In this push scanning, scanning is started by instructing to start scanning from an operation panel of an image reading apparatus, and read image data is transmitted to an external device such as an information terminal.

### SUMMARY

The present disclosure is directed to improving usability in terms of settings for processing executed by the processing apparatus.

A processing apparatus according to one aspect of the present disclosure includes: at least one memory and at least one processor which functions as: a reception unit configured to receive a first operation for executing specific processing; a control unit configured to transmit an instruction to display a setting screen related to the specific processing to an information terminal, based on the receipt of the first operation, and to perform control to receive a setting content set on the setting screen from the information terminal; and a processing unit configured to perform the specific processing using the received setting content.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram showing a configuration example of a processing system;

FIG. 2 is a block diagram showing a hardware configuration example of an information terminal;

FIG. 3 is a block diagram showing a hardware configuration example in a case where a processing apparatus is an MFP;

FIG. 4 is a block diagram showing an example of a software functional configuration of an image input application;

FIG. 5 is a sequence chart showing an example of pseudo push scanning performed between the MFP and the information terminal;

FIG. 6 is a diagram showing an example of a scan standby screen;

FIG. 7 is a diagram showing an example of a scan advanced setting screen;

FIG. 8 is a flowchart showing an example of processing procedures executed by the MFP;

FIG. 9 is a diagram showing an example of a guide screen;

FIG. 10 is a flowchart showing processing procedures executed by the image input application;

FIG. 11 is a diagram showing an example of a scan advanced setting screen according to a second embodiment;

FIG. 12 is a flowchart showing processing procedures executed by an image input application according to the second embodiment; and

FIG. 13 is a flowchart showing an example of processing procedures executed by an MFP according to a third embodiment.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. Incidentally, an identical reference numeral is assigned to an identical constituent and an explanation thereof is made.

### First Embodiment

### <<Overview>>

In push scanning of the related art, basic scan settings are configured through an operation panel of an image reading apparatus. However, advanced scan settings need to be configured using an image input application (image input APP) installed on an external device such as an information terminal. Therefore, an example will be described below where advanced scan settings can be easily configured without a user consciously launching the image input application.

### <<Configuration of Processing System>>

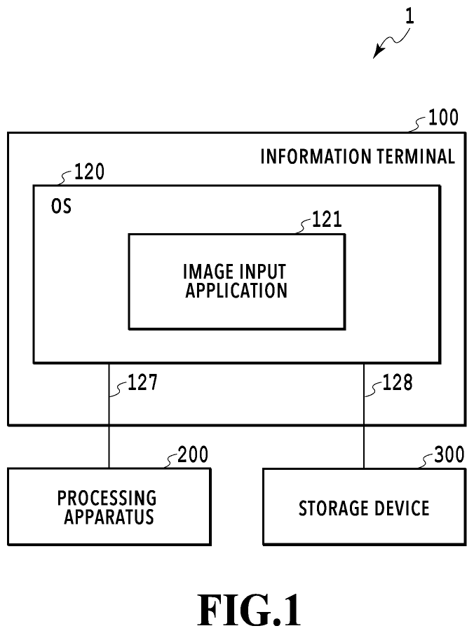

FIG. 1 is a block diagram showing a configuration example of a processing system 1. The processing system 1 includes an information terminal 100, a processing apparatus 200, and a storage device 300. The processing apparatus 200 and the storage device 300 are peripheral devices of the information terminal 100 and are connected to the information terminal 100.

The information terminal 100 is an information terminal apparatus such as a personal computer (PC), a tablet terminal apparatus, or a smartphone. An operating system (OS) 120 is installed on the information terminal 100. An image input application 121 for configuring advanced scan settings is also installed on the information terminal 100. The image input application 121 runs on the OS 120.

The processing apparatus 200 is not particularly limited, as long as the apparatus executes processing (functions) whose setting can be changed. For example, the processing apparatus 200 may be a multifunctional peripheral (MFP) having a plurality of functions integrated, or may be a copier. Alternatively, the processing apparatus 200 may be a facsimile machine, a scanner, or a digital camera. In this embodiment, the processing apparatus 200 is the MFP. The processing apparatus 200 is bi-directionally and communicatively connected to the information terminal 100 through an interface 127. The interface 127 may be a network such as the Internet or a local area network (LAN), or may be a bus (signal line) such as a serial bus or a parallel bus.

The storage device 300 is not particularly limited as long as it is capable of storing data. The storage device 300 may be an auxiliary storage device or a random access memory (RAM). The storage device 300 may also be built into the information terminal 100 or into a server on a network. The storage device 300 is bi-directionally and communicatively connected to the information terminal 100 through an interface 128. The interface 128 may be a network or a bus (signal line).

### <<Hardware Configuration of Information Terminal>>

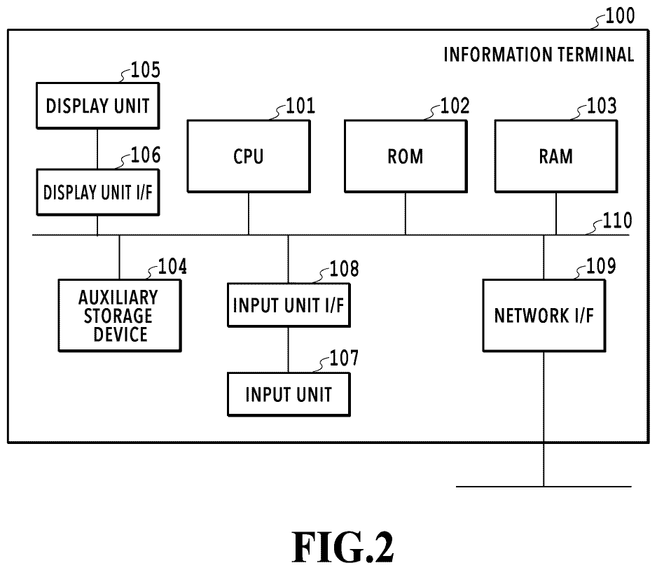

FIG. 2 is a block diagram showing a hardware configuration example of the information terminal 100. The information terminal 100 includes a central processing unit (CPU) 101, a read-only memory (ROM) 102, a RAM 103, an auxiliary storage device 104, and a display unit 105. The information terminal 100 also includes a display unit interface (I/F) 106, an input unit 107, an input unit I/F 108, and a network I/F 109. The CPU 101, the ROM 102, the RAM 103, the auxiliary storage device 104, the display unit I/F 106, the input unit I/F 108, and the network I/F 109 are all connected to a bus 110 so that data can be transmitted to and received from each other.

The CPU 101 is a processing unit for realizing various functions of the information terminal 100. The CPU 101 includes at least one processor. The CPU 101 performs various processing by executing programs (computer programs) or activating hardware. The programs are executed by being expanded in the RAM 103. The processing by the CPU 101 includes control for causing the information terminal 100 to operate. The processing by the CPU 101 may be performed in cooperation with a graphics processing unit (GPU) (not shown).

The ROM 102 stores various types of data. For example, the ROM 102 stores basic software such as a basic input output system (BIOS) used to control the information terminal 100. The ROM 102 also stores setting data that does not have to be changed.

The RAM 103 is a memory having an area for storing data. Examples of such data include computer programs and data loaded from the ROM 102, the auxiliary storage device 104 or the like, or various computer programs and data received from outside through the network I/F 109. The RAM 103 also has a work area used by the CPU 101 to execute various processing. The RAM 103 thus provides various areas as needed.

The auxiliary storage device 104 is a large-capacity information storage device typified by a hard disk drive. The auxiliary storage device 104 stores the OS 120 (FIG. 1), various driver software, various application software, and the like. One of the various application software is the image input application 121 (FIG. 1).

The driver software stored in the auxiliary storage device 104 includes, for example, display control driver software for controlling display on the display unit 105 through the display unit I/F 106. The driver software stored in the auxiliary storage device 104 includes keyboard driver software for controlling a keyboard of the input unit 107 and pointing device driver software for controlling a pointing device of the input unit 107. The driver software stored in the auxiliary storage device 104 also includes a network driver for controlling communication through the network I/F 109. The driver software stored in the auxiliary storage device 104 also includes driver software for controlling the processing apparatus 200. Examples of the driver software for controlling the processing apparatus 200 include a scanner driver, a FAX (facsimile) driver, and the like.

The auxiliary storage device 104 further stores computer programs and data used for the CPU 101 to execute various processing to be described later as the processing performed by the information terminal 100. The computer programs and data stored in the auxiliary storage device 104 are loaded into the RAM 103 as appropriate under the control of the CPU 101, and become the target of processing by the CPU 101.

The display unit 105 is a display device such as a CRT or liquid crystal display. The display unit 105 displays results of processing by the CPU 101, using symbols such as images and characters. The display unit 105 may also be a projection device that projects symbols such as images and characters. Examples of the projection device include a projector and the like. The display unit 105 may also be a touch panel with display and user interface functions.

The input unit 107 is a user interface device (operation unit) operated by an operator (user) of the information terminal 100 to input various instructions to the CPU 101. Examples of the user interface device include a keyboard, a pointing device, and the like.

The network I/F 109 is an interface for data communication with external devices. Examples of the interface include a network board and the like.

### <<MFP Hardware Configuration>>

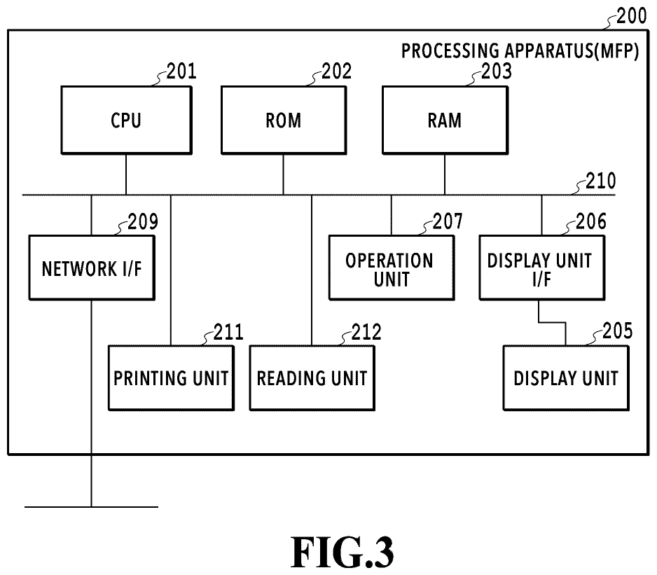

FIG. 3 is a block diagram showing a hardware configuration example in a case where the processing apparatus 200 is an MFP. The MFP includes a CPU 201, a ROM 202, a RAM 203, a display unit 205, and a display unit I/F 206. The MFP also includes an operation unit 207, a network I/F 209 as a communication unit, a printing unit 211, and a reading unit 212. The CPU 201, the ROM 202, the RAM 203, the display unit I/F 206, the operation unit 207, the network I/F 209, the printing unit 211, and the reading unit 212 are all connected to a bus 210 so that data can be transmitted to and received from each other.

The CPU 201 performs various processing by executing programs (computer programs). The programs are executed by being expanded in the RAM 203. The processing by the CPU 201 includes control for the MFP to perform various operations.

The ROM 202 stores various types of data. The ROM 202 stores, for example, computer programs and data used for the CPU 201 to execute or control various processing performed by the MFP.

The RAM 203 is a memory having an area for storing data. Examples of such data include computer programs and data loaded from the ROM 202, or various computer programs and data received from outside through the network I/F 209. The RAM 203 also has a work area used by the CPU 201 to execute various processing. The RAM 203 thus provides various areas as needed.

The display unit 205 is a touch panel having a liquid crystal layer and a touch sensor layer. The display unit 205 is controlled by the display unit I/F 206. This control causes results of processing by the CPU 201 to be displayed as symbols such as images and characters on the liquid crystal layer. The touch sensor layer also detects a touch input and outputs the detection result to the CPU 201.

The operation unit 207 is an input device such as a hard key. The network I/F 209 performs data communication with external devices. The printing unit 211 records (prints) symbols such as images and characters on a printing medium such as paper, based on print data.

The reading unit 212 is a device capable of executing scanning processing to scan a document under the control of the CPU 201. The reading unit 212 may be composed of an optical unit including a charged coupled device (CCD), a reading light source, and the like. Upon execution of the scanning processing, the reading unit 212 generates image data representing the scanned document. The image data generated by the reading unit 212 is sent to the information terminal 100 through the network I/F 109.

In the example of FIG. 3, the MFP is configured to include a printer device (printing unit 211) and a scanner device (reading unit 212). In a case of including a FAX device, the MFP is further configured to send and receive faxes.

### <<Software Functional Configuration of Information Terminal>>

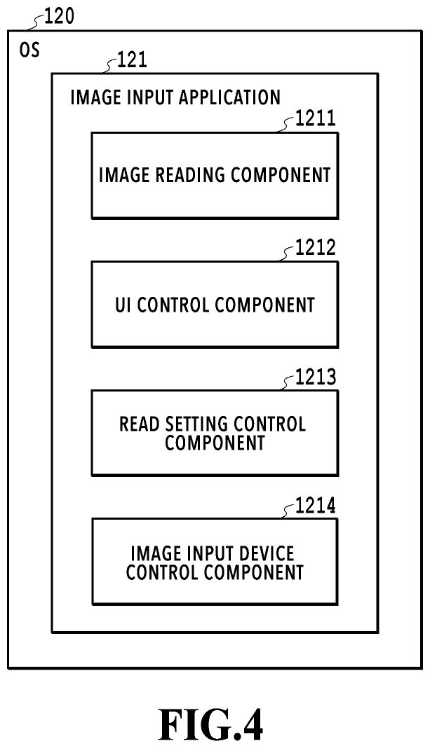

FIG. 4 is a block diagram showing an example of a software functional configuration of the image input application 121. The image input application 121 includes an image reading component 1211, a UI control component 1212, a read setting control component 1213, and an image input device control component 1214.

The image reading component 1211 scans an image and generates image data representing the scanned image. The image reading component 1211 also stores the generated image data in the auxiliary storage device 104 or the like.

The UI control component 1212 displays a screen (scan advanced setting screen) on the display unit 105 for configuring scan advanced settings. The UI control component 1212 can receive scan settings through the scan advanced setting screen.

The read setting control component 1213 determines a setting content for the reading unit 212 included in the MFP, based on the scan settings received by the UI control component 1212.

The image input device control component 1214 transmits data including the setting content for the reading unit 212 determined by the read setting control component 1213 and a scan start instruction to the MFP through the network I/F 109. The image input device control component 1214 can also monitor the MFP and receive data from the MFP through the network I/F 109.

### <<Pseudo Push Scanning>>

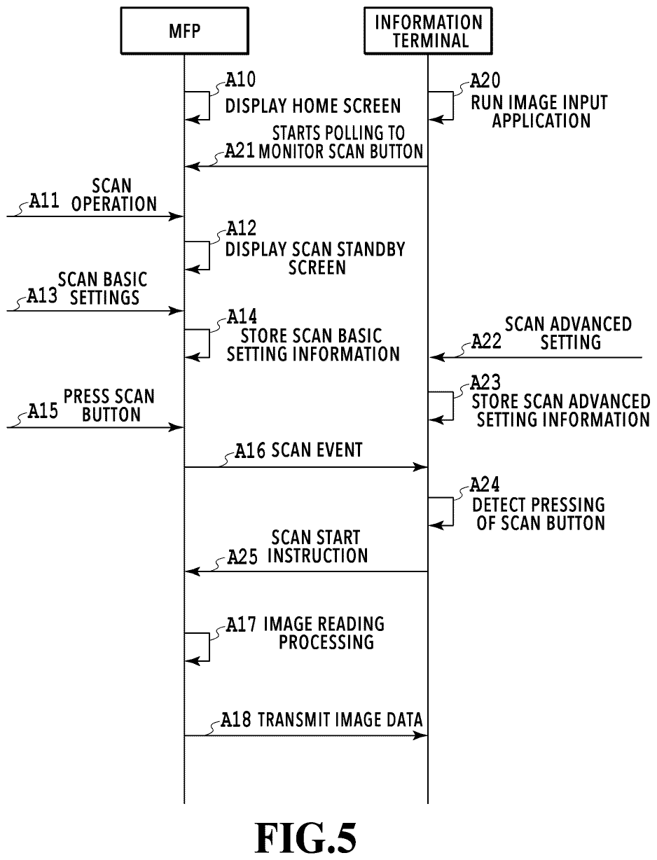

FIG. 5 is a sequence chart showing an example of pseudo push scanning performed between the MFP and the information terminal 100. In the pseudo push scanning, the MFP receives a scan instruction, and then the information terminal 100 sends scan settings to the MFP. The MFP then sends image data obtained by scanning according to the scan settings to the information terminal 100.

Upon receipt of a start instruction, the MFP displays a home screen on the display unit 205 (A10). This home screen displays icons for receiving a scan operation, a copy operation, a FAX operation, and the like.

In the information terminal 100, as the image input application 121 installed on the information terminal 100 is launched (A20), the image input application 121 starts polling to monitor the state of a scan button of the MFP (A21). The image input application 121 may be launched by a user operation, or may be launched automatically upon start-up of the OS 120. The scan button (scan button 602 to be described later) of the MFP is a display item displayed on the display unit 205 after an operation on a scan item is received from the home screen, and is an operation item for receiving a scan instruction from the user.

Upon receipt of advanced settings as the scan settings through the user operation (A22), the image input application 121 stores scan detailed information (A23). The scan detailed information indicates a setting content configured in the advanced settings.

Upon receipt of a scan operation via an icon displayed on the home screen (A11), the MFP displays a scan standby screen on the display unit 205 (A12). While displaying the scan standby screen, the MFP may receive basic settings as the scan settings through a user operation. Upon receipt of the basic settings (A13), the MFP stores scan basic information (A14). The scan basic information indicates a setting content configured in the basic settings.

Upon receipt of a user operation of pressing the scan button provided in the scan standby screen (A15), the MFP transmits a scan event, which is an event of scanning, to the information terminal 100 (A16).

The information terminal 100 receives the scan event transmitted from the MFP. Based on the received scan event, the image input application 121 of the information terminal 100 detects pressing of the scan button in the MFP (A24). In response to this detection, the image input application 121 transmits a scan start instruction to the MFP (A25). There are cases where scan detailed information is transmitted together with the scan start instruction and where the scan detailed information is not transmitted together with the scan start instruction.

Upon receipt of the scan start instruction transmitted from the information terminal 100, the MFP starts image reading processing and controls the reading unit 212 (A17). In accordance with this control, the reading unit 212 reads an image. The MFP transmits image data representing the image read by the reading unit 212 to the information terminal 100 (A18).

### <<Scan Standby Screen>>

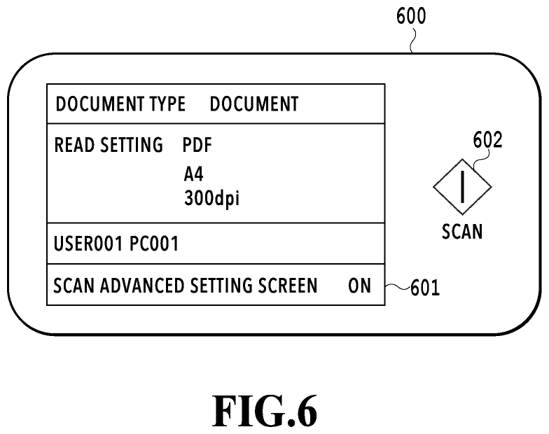

FIG. 6 is a diagram showing an example of a scan standby screen 600. As described above, the scan standby screen 600 is displayed on the display unit 205 of the MFP as the MFP receives a scan operation by the user. The scan standby screen 600 includes a display setting item 601 and the scan button 602.

The display setting item 601 is a setting item that allows setting of whether to display a scan advanced setting screen on the display unit 105 of the information terminal 100 in response to pressing (touching) the scan button 602. Specifically, the display setting item 601 allows ON/OFF setting of the display of the scan advanced setting screen. In the example of FIG. 6, the scan advanced setting screen is set to be displayed on the display unit 105 of the information terminal 100 in response to pressing the scan button 602. In other words, the display of the scan advanced setting screen is set to ON in the example of FIG. 6. The scan button 602 is an operation icon (operation item) for receiving a scan execution instruction from the user.

The scan settings include basic settings and advanced settings. The basic settings are scan settings that are defined as basic (standard). The basic settings can be configured on either the information terminal 100 or the MFP. That is, the basic settings can be configured by the input unit 107 of the information terminal 100 or by the operation unit 207 of the MFP. The basic settings include setting items such as document size setting and resolution setting, for example. The document size setting is a setting item that allows setting of a document size to be scanned. The resolution setting is a setting item that allows setting of a scan resolution.

The advanced settings are scan settings other than the basic settings. The advanced settings can be configured on the information terminal 100 but not on the MFP. In other words, the advanced settings can be configured by the input unit 107 of the information terminal 100, but not by the operation unit 207 of the MFP. The advanced settings include setting items such as data format setting. The data format setting is a setting item that allows setting of a data format (file format) of image data obtained by scanning.

The scan standby screen 600 displays a scan setting state. In the example of FIG. 6, a state of the data format setting is PDF, a state of the document size setting is A4, and a state of the resolution setting is 300 dpi.

The data format setting is the advanced setting in this embodiment. Therefore, the data format setting can be changed on the information terminal 100 but not on the MFP. If the user wishes to change the advanced settings, he/she sets the display of the advanced setting screen to ON in the display setting item 601. Furthermore, unlike the data format setting, if the user wishes to change settings that are not the basic settings, he/she sets the display of the advanced setting screen to ON in the display setting item 601.

The document size setting and the resolution setting are the basic settings in this embodiment, and thus can be changed on both the information terminal 100 and the MFP. If the user wishes to change only the basic settings, or if the user does not wish to change the scan settings, he/she may set the display of the advanced setting screen to OFF in the display setting item 601.

### <<Scan Advanced Setting Screen>>

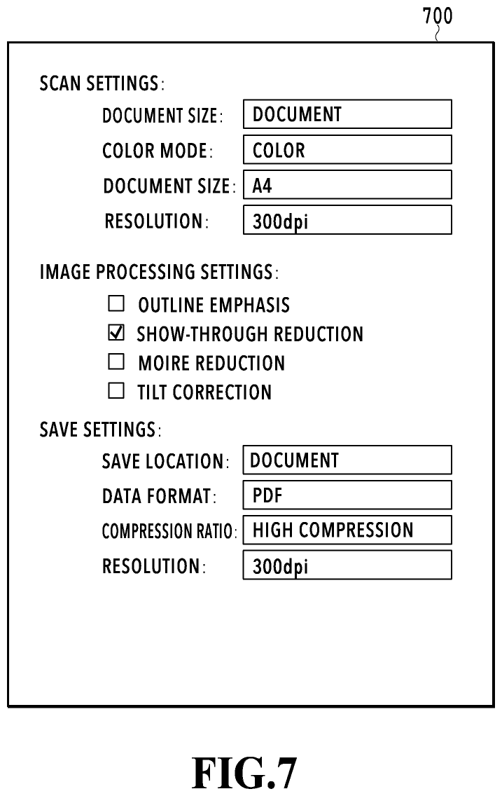

FIG. 7 is a diagram showing an example of a scan advanced setting screen 700. This scan advanced setting screen 700 is displayed on the display unit 105 of the information terminal 100 if the display of the scan advanced setting screen is set to ON in the display setting item 601 (FIG. 6) described above. The scan advanced setting screen 700 is not displayed on the display unit 205 of the MFP. The scan advanced setting screen 700 includes not only the setting items of the basic settings that can be configured on the MFP, but also setting items of the advanced settings different from the setting items of the basic settings. The scan advanced setting screen 700 also includes more setting items than the setting items that can be set on the MFP.

In the example of FIG. 7, in addition to the setting items of the document size setting, resolution setting, and data format setting described above, setting items of document type setting, color mode setting, image processing setting, save location setting, compression ratio setting, and the like are included. The document type setting is a setting item that allows setting of the type of document to be scanned. The color mode setting is a setting item that allows setting of whether to read the document to be scanned in color or in black and white. The image processing setting is a setting item that allows setting of details of image processing such as outline emphasis, show-through reduction, moire reduction, and tilt correction. The save location setting is a setting item that allows setting of a save location for image data obtained as a scan result. The compression ratio setting is a setting item that allows setting of a compression ratio for the image data obtained as the scan result.

The user can configure various scan settings using the input unit 107 on the scan advanced setting screen 700. In the example of FIG. 7, the user can configure scan settings by checking a checkbox for the desired scan setting or by selecting the desired scan setting from a pull-down menu.

### <<Processing Procedures by MFP>>

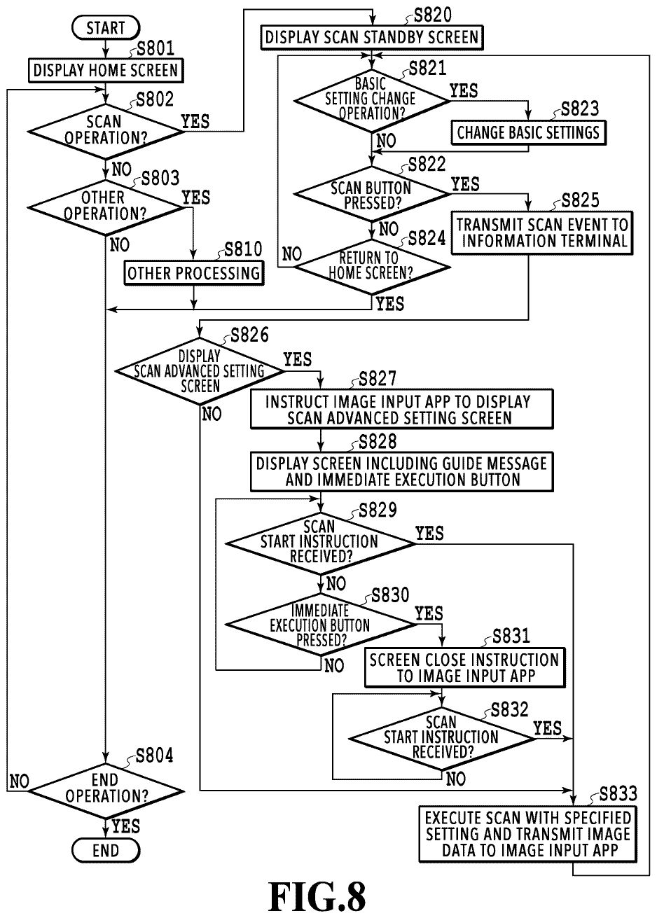

FIG. 8 is a flowchart showing an example of processing procedures executed by the MFP. A series of processing in the flowchart shown in FIG. 8 is implemented by the CPU 201 reading a program stored in the ROM 202 or the like into the RAM 203 and executing the program. Note that some or all of the series of processing in the flowchart shown in FIG. 8 may be implemented by hardware such as an ASIC or electronic circuit. In the following description of the flowchart, the symbol “S” represents a step.

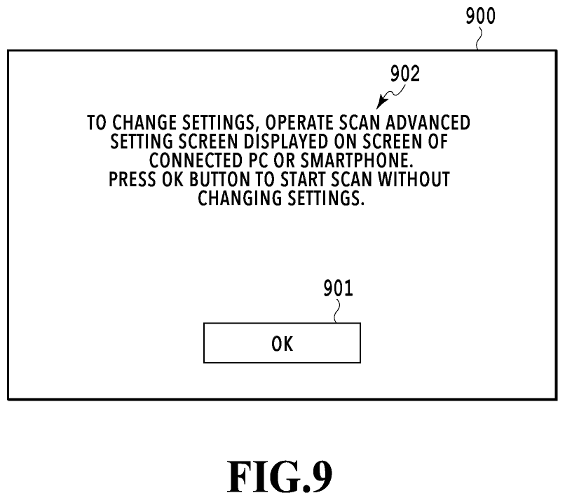

FIG. 9 is a diagram showing an example of a guide screen 900. With reference to FIGS. 8 and 9, the processing executed by the MFP will be described below. The series of processing in the flowchart shown in FIG. 8 starts as the MFP is activated.

In S801, the CPU 201 displays the home screen on the display unit 205. The processing then proceeds to S802, where the CPU 201 judges whether a scan operation is received. If no scan operation is received, the processing proceeds to S803. In S803, the CPU 201 judges whether an operation other than the scan operation for executing a plurality of functions of the MFP, such as a copy operation or a FAX operation, for example, is received. If no other operation is received, the processing proceeds to S804. If another operation is received, the processing proceeds to S810, where the CPU 201 performs copy processing corresponding to the copy operation, FAX processing corresponding to the FAX operation, or the like. The processing then proceeds to S804.

In S804, the CPU 201 judges whether an end operation to stop the operation of the MFP is received. If the end operation is received, the series of processing ends. If the end operation is not received, the processing returns to S802.

If the scan operation is received in S802, the processing proceeds to S820. In S820, the CPU 201 displays the scan standby screen 600 (FIG. 6) on the display unit 205. The processing then proceeds to S821, where the CPU 201 judges whether an operation to change the basic settings as the scan settings is received. If the operation to change the basic settings is not received, the processing proceeds to S822. If the operation to change the basic settings is received, the processing proceeds to S823, where the CPU 201 changes the basic settings. The processing then proceeds to S822.

In S822, the CPU 201 judges whether the scan button 602 (FIG. 6) is pressed. If the scan button 602 is not pressed, the processing proceeds to S824. In S824, the CPU 201 judges whether a user operation to return to the home screen is received. If the user operation to return to the home screen is received, the processing proceeds to S804. If the user operation to return to the home screen is not received, the processing returns to S821.

If the scan button 602 is pressed in S822, the processing proceeds to S825. In S825, the CPU 201 transmits a scan event to the information terminal 100. The processing then proceeds to S826.

In S826, the CPU 201 judges the setting received in the display setting item 601 (FIG. 6) on the scan standby screen 600. That is, the CPU 201 judges whether the display setting for the scan advanced setting screen 700 (FIG. 7) is received as ON or OFF. If the display setting for the scan advanced setting screen 700 is received as OFF, the processing proceeds to S833. If the display setting for the scan advanced setting screen 700 is received as ON, the processing proceeds to S827.

In S827, the CPU 201 instructs the image input application 121 running on the information terminal 100 to display the scan advanced setting screen 700. That is, a request to display the scan advanced setting screen 700 is transmitted to the information terminal 100. The processing then proceeds to S828.

Note that, if the display setting for the scan advanced setting screen 700 is ON on the scan standby screen 600, the instruction to display the scan advanced setting screen 700 in S827 and the transmission of the scan event in S825 may be performed at the same time. In this case, a packet containing both a scan event and a command to instruct the display of the scan advanced setting screen 700, for example, is transmitted to the information terminal 100. On the other hand, if the display setting for the scan advanced setting screen 700 is ON on the scan standby screen 600, the processing of transmitting the scan event in S825 does not have to be performed.

In S828, the CPU 201 displays the guide screen 900 on the display unit 205. The processing then proceeds to S829. The guide screen 900 is a screen for prompting the information terminal 100 to perform an operation to change the settings. The guide screen 900 is provided with an immediate execution button 901 and a guide message 902. The immediate execution button 901 is an operation item (display item) for receiving an instruction to execute a scan without changing the scan settings from the user. Specifically, the immediate execution button 901 is used in a case where the display setting for the scan advanced setting screen 700 is ON but the scan settings are not to be changed. The guide message 902 displays a guidance regarding the settings for the scan processing. For example, a message is displayed prompting the information terminal 100 to perform an operation to change the settings. Alternatively, an explanation for using the immediate execution button 901 is displayed.

In S829, the CPU 201 judges whether a scan start instruction is received from the image input application 121. If the scan start instruction is received, the processing proceeds to S833. If the scan start instruction is not received, the processing proceeds to S830.

In S830, the CPU 201 judges whether the pressing (touching) of the immediate execution button 901 is received. If the pressing of the immediate execution button 901 is not received, the processing returns to S829. If the pressing of the immediate execution button 901 is received, the processing proceeds to S831.

In S831, the CPU 201 issues a screen close instruction to the image input application 121 to close the scan advanced setting screen 700. In other words, a request to end the display of the scan advanced setting screen 700 is transmitted to the information terminal 100. The processing then proceeds to S832. In S832, the CPU 201 judges whether a scan start instruction is received from the image input application 121 (information terminal 100). If the scan start instruction is not received, the processing remains in S832. Upon receipt of the scan start instruction, the processing proceeds to S833.

In S833, the CPU 201 executes the scan processing using the setting content specified by the image input application 121. In this case, the CPU 201 controls the reading unit 212 to execute the scan using the setting content specified by the image input application 121. The CPU 201 transmits image data obtained by the reading unit 212 through the execution of the scan processing to the image input application 121. The processing then returns to S821.

Note that, upon receipt of the screen close instruction for the scan advanced setting screen 700 in response to receiving the pressing of the immediate execution button 901, the image input application 121 transmits a default setting content along with the scan start instruction. In this case, the CPU 201 executes scan processing using the default setting content. The default setting content may be a setting content used for the previous scan processing. On the other hand, if the screen close instruction for the scan advanced setting screen 700 is not received, the image input application 121 (information terminal 100) transmits the setting content set on the scan advanced setting screen 700 along with the scan start instruction. In this case, the CPU 201 executes scan processing using the setting content set on the scan advanced setting screen 700.

Upon receipt of the screen close instruction for the scan advanced setting screen 700 in response to receiving the pressing of the immediate execution button 901, the image input application 121 does not have to transmit the default setting content. In this case, the CPU 201 executes the scan processing without changing the settings.

### <<Processing Procedures by Image Input Application>>

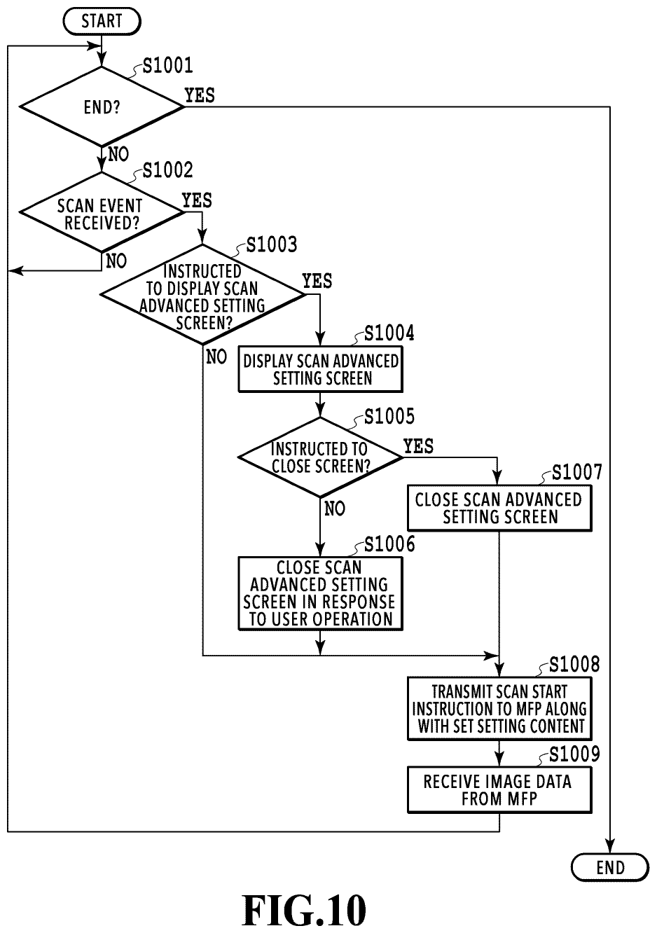

FIG. 10 is a flowchart showing processing procedures executed by the image input application 121. A series of processing in the flowchart shown in FIG. 10 is implemented by the CPU 101 of the information terminal 100 reading a program code of the image input application 121 stored in the auxiliary storage device 104 into the RAM 103 and executing (activating) the program code. Note that some or all of the series of processing in the flowchart shown in FIG. 10 may be implemented by hardware such as an ASIC or electronic circuit.

The series of processing in the flowchart shown in FIG. 10 starts as the program code of the image input application 121 is read into the RAM 103 and executed (started) on the OS 120 of the information terminal 100. The image input application 121 may be run in response to a user operation. Alternatively, the image input application 121 may be run automatically in response to the start-up of the OS 120.

In S1001, the CPU 101 judges whether an instruction to end the image input application 121 is received from the user. If the end instruction is received, the CPU 101 ends the image input application 121, and the series of processing in the flowchart shown in FIG. 10 ends. If the end instruction is not received, the processing proceeds to S1002.

In S1002, the CPU 101 judges whether a scan event is received from the MFP. If no scan event is received, the processing returns to S1001. If the scan event is received, the processing proceeds to S1003. As mentioned above, if the MFP does not perform the processing of transmitting a scan event in S725, the processing of S1002 is not performed. In other words, the processing of S1002 is omitted from the flowchart shown in FIG. 10.

In S1003, the CPU 101 judges whether an instruction to display the scan advanced setting screen 700 (FIG. 7) is received from the MFP. If the MFP separately transmits a scan event and an instruction to display the scan advanced setting screen 700, the CPU 101 judges whether the instruction to display the scan advanced setting screen 700 is received within a predetermined time after receiving the scan event. If the MFP simultaneously transmits a scan event and an instruction to display the scan advanced setting screen 700, the CPU 101 judges whether information including the scan event also includes the instruction to display the scan advanced setting screen 700. If the instruction to display the scan advanced setting screen 700 is not received, the processing proceeds to S1008. If the instruction to display the scan advanced setting screen 700 is received, the processing proceeds to S1004.

In S1004, the CPU 101 displays the scan advanced setting screen 700. The processing then proceeds to S1005. In S1005, the CPU 101 judges whether a screen close instruction for the scan advanced setting screen 700 is received from the MFP. If the screen close instruction is not received, the processing proceeds to S1006. If the screen close instruction is received, the processing proceeds to S1007.

In S1006, the CPU 101 waits for a user operation to close the scan advanced setting screen 700. If the user operation to close the scan advanced setting screen 700 is received, the CPU 101 determines a setting content for the reading unit 212. For example, the CPU 101 determines the scan settings specified in the various setting items on the scan advanced setting screen 700 as the setting content for the reading unit 212. The processing then proceeds to S1008.

In S1007, the CPU 101 closes the scan advanced setting screen 700. The CPU 101 also determines a setting content for the reading unit 212 in a case where the screen close instruction is received from the MFP. For example, the CPU 101 determines the same setting content as the setting content of the previous scan settings as the setting content for the reading unit 212. In this case, the MFP performs scan processing without changing the settings.

In S1008, the CPU 101 transmits data containing the setting content for the reading unit 212 determined in S1006 or S1007 and a scan start instruction to the MFP through the network I/F 109. The processing then proceeds to S1009.

In S1009, the CPU 101 waits to receive image data transmitted from the MFP. Upon receiving the image data, the CPU 101 stores the received image data in the auxiliary storage device 104. The processing then returns to S1001.

As described in detail above, usability can be improved according to this embodiment. For example, the CPU 201 of the MFP as a control unit transmits an instruction to display the scan advanced setting screen 700 to the information terminal 100, upon receipt of a first operation of pressing the scan button 602. The CPU 201 also receives the setting content set on the scan advanced setting screen 700 from the information terminal 100. Then, the CPU 201, as a processing unit, controls the reading unit 212 to execute specific processing (scan processing) using the setting content set on the scan advanced setting screen 700. This makes it possible to display the scan advanced setting screen 700 on the information terminal 100 without explicitly running the image input application 121 installed on the information terminal 100 through a user operation. Even if it is difficult to display or operate the scan advanced setting screen 700 using the display unit 205 of the MFP, the display unit 105 of the information terminal 100 may be used to configure the MFP settings. Furthermore, on the MFP, it is possible to set through a user operation whether to display the scan advanced setting screen 700 in response to an operation of the scan button 602. This makes it possible for the user who only uses the basic settings to choose not to display the scan advanced setting screen 700, thereby maintaining the usability.

### Second Embodiment

### <<Overview>>

In this embodiment, a scan advanced setting screen different from the scan advanced setting screen 700 is used, and it is possible not only on the MFP but also on the information terminal 100 to set whether to display the scan advanced setting screen. Note that the following description will omit description of the same content as that of the first embodiment as appropriate and focus primarily on differences.

### <<Scan Advanced Setting Screen>>

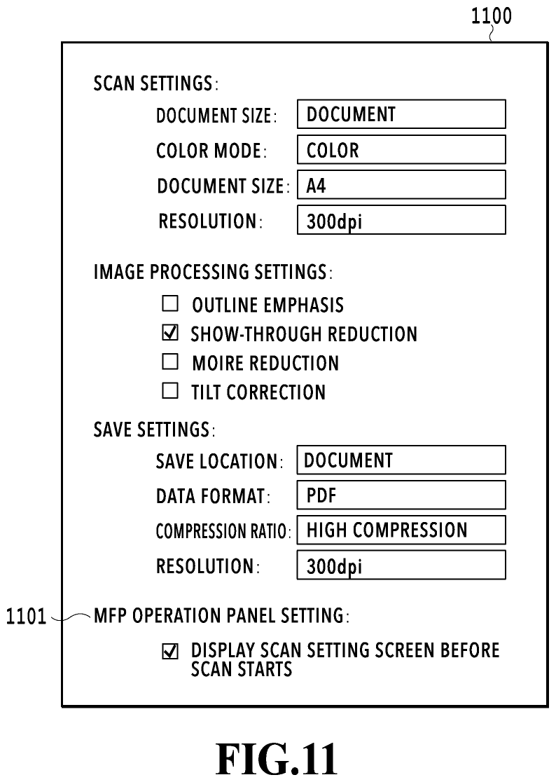

FIG. 11 is a diagram showing an example of a scan advanced setting screen 1100 according to a second embodiment. The scan advanced setting screen 1100 of this embodiment includes a display setting item 1101, in addition to the scan advanced setting screen 700 of the first embodiment. The display setting item 1101 is a setting item that allows setting of whether to display the scan advanced setting screen 1100 on the information terminal 100. In the example of FIG. 11, it is possible to set, using a checkbox, whether to display the scan advanced setting screen 1100 on the information terminal 100, but the present disclosure is not limited thereto.

### <<Processing Procedures by Image Input Application>>

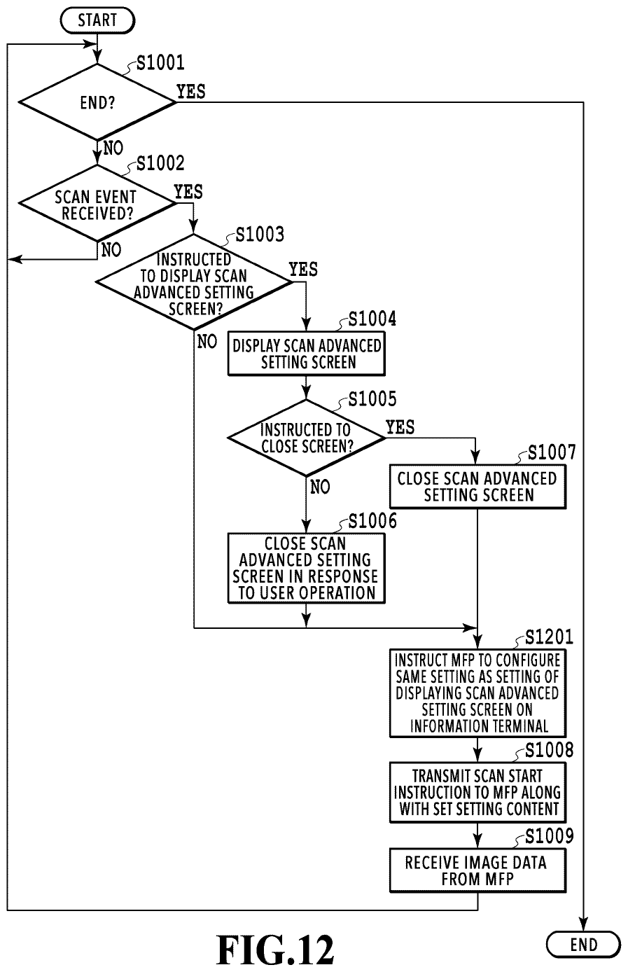

FIG. 12 is a flowchart showing processing procedures executed by the image input application 121 according to the second embodiment. In this embodiment, processing of S1201 is newly added to the flowchart shown in FIG. 10.

The processing of S1201 is performed after S1003, S1006 or S1007. In S1201, the CPU 101 checks the setting of the display setting item 1101. If the setting of the display setting item 1101 is to display the scan advanced setting screen 1100 on the information terminal 100, the CPU 101 transmits a setting instruction to the MFP to configure the same setting. The processing then proceeds to S1008.

In the MFP, upon receiving the setting instruction described above from the information terminal 100, the CPU 201 sets the setting of the display setting item 601 on the scan standby screen 600 (FIG. 6) to ON if it is OFF.

As described above, according to this embodiment, the setting of whether to display the scan advanced setting screen 1100 on the information terminal 100 can be performed not only on the MFP but also on the information terminal 100. This improves the usability for the user.

### Third Embodiment

### <<Overview>>

In this embodiment, even if the scan advanced setting screen 700 is set to be displayed on the information terminal 100, an operation of not changing the scan settings may be performed on the MFP. Note that the following description will omit description of the same content as that of the first embodiment as appropriate and focus primarily on differences.

### <<Processing Procedures by MFP>>

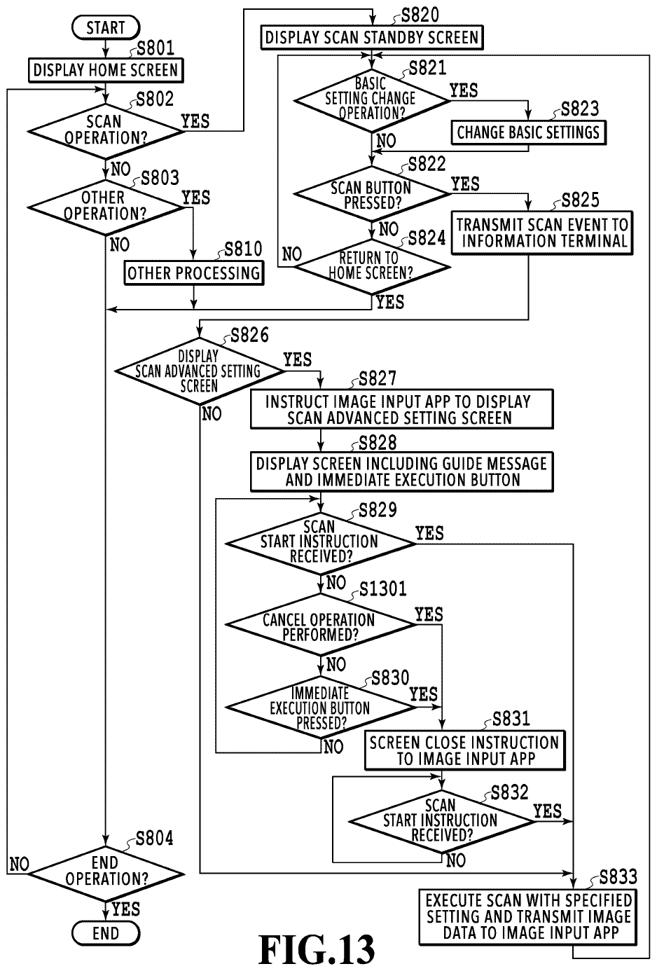

FIG. 13 is a flowchart showing an example of processing procedures executed by an MFP according to a third embodiment. In this embodiment, processing of S1301 is newly added to the flowchart shown in FIG. 8.

The processing of S1301 is performed after S829. In S1301, the CPU 201 judges whether a cancel operation is performed to cancel the scan settings configured on the scan advanced setting screen 700. For example, the CPU 201 judges whether the scan button 602 on the scan standby screen 600 (FIG. 6) is pressed (long-pressed) for a certain period of time. This certain period of time is set to, for example, three seconds. This certain period of time may be changeable by a user operation.

If the scan button 602 is not pressed for the certain period of time, the CPU 201 judges that the cancel operation is not performed. In this case, the processing proceeds to S830. On the other hand, if the scan button 602 is pressed for the certain period of time, the CPU 201 judges that the cancel operation is performed. In this case, the processing proceeds to S831.

As described above, according to this embodiment, in response to receiving a second operation (cancel operation) performed by long-pressing the scan button 602, the scan processing can be executed without changing the scan settings. This improves the usability for the user. Note that the second operation may be an operation other than long-pressing the button. For example, the second operation may be an operation that is distinguishable from normal pressing of the scan button 602, such as double-clicking the button.

Note that if a certain period of time has passed since the guide screen 900 was displayed in S829, the CPU 201 may consider that the immediate execution button 901 is pressed. In this case, the CPU 201 executes scan processing without changing the settings (that is, without conforming to a setting change operation performed on the information terminal 100). Similar to S831, the CPU 201 also transmits a request to the information terminal 100 to end the display of the scan advanced setting screen 700 after the elapse of the certain period of time. This may be applied to the first embodiment or the second embodiment.

Alternatively, if a certain period of time has passed since the guide screen 900 was displayed in S829, the CPU 201 may issue a warning; and then, if a further period of time has passed since the warning, may consider that the immediate execution button 901 is pressed. In this case, the CPU 201 performs scan processing without changing the settings (that is, without conforming to a setting change operation performed on the information terminal 100). The CPU 201 also transmits a request to the information terminal 100 to end the display of the scan advanced setting screen 700. This may be applied to the first embodiment or the second embodiment. The warning may be a voice and displayed on the display unit 205 or the guide screen 900. Alternatively, the warning may be a flashing of at least part of the display unit 205 or the guide screen 900. Alternatively, the warning may be a vibration of the operation unit 207, or the like.

### <<Other Embodiments>>

The present disclosure is not limited to the above-described embodiments.

### <<Application to Camera

The processing apparatus 200 is appliable to a camera instead of the MFP. For example, an embodiment may include displaying a setting screen for configuring various settings for the camera on a smartphone as the information terminal 100. This setting screen allows for setting of setting items that cannot be set on the camera, in addition to setting items that can be set on the camera, for example.

Upon receipt of a shooting instruction in response to a first operation, such as pressing a shutter by the user, the CPU 201 of the camera instructs the smartphone to display the setting screen. The user changes settings related to shooting with the camera through the setting screen displayed on the smartphone. The CPU 101 of the smartphone transmits a shooting start instruction to the camera along with the setting content set on the setting screen. Upon receiving the setting content set on the setting screen and the shooting start instruction, the CPU 201 of the camera executes specific processing (shooting processing) using the setting content. The CPU 201 of the camera also transfers image data obtained by executing the specific processing (shooting processing) to the smartphone. The camera has an immediate execution button. As this button is pressed, the CPU 201 of the camera executes the specific processing (shooting processing) with default settings without waiting for the shooting start instruction from the smartphone. The immediate execution button may be a soft key or a hard key, or may be both a soft key and a hard key.

In this way, settings that are difficult to display on an operation screen provided in a camera main body can be configured on a screen of the information terminal 100 such as a smartphone, thus improving the usability for the user. Specifically, even in a case of using a camera as the processing apparatus 200, the present disclosure can improve the usability in the same way as in the case of using the MFP as the processing apparatus 200.

### <<Application to Robot Vacuum Cleaner>>

The processing apparatus 200 is applicable to a robot vacuum cleaner instead of the MFP. For example, an embodiment may include displaying a setting screen for configuring various settings for the robot vacuum cleaner on a smartphone as the information terminal 100. This setting screen allows for setting of setting items that cannot be set on the robot vacuum cleaner, in addition to setting items that can be set on the robot vacuum cleaner, for example.

Upon receipt of a cleaning start instruction in response to a first operation, such as pressing a shutter by the user, the CPU 201 of the robot vacuum cleaner instructs the smartphone to display the setting screen. The user changes settings of the robot vacuum cleaner through the setting screen displayed on the smartphone. The CPU 101 of the smartphone transmits the cleaning start instruction to the robot vacuum cleaner along with the setting content set on the setting screen. Upon receiving the setting content set on the setting screen and the cleaning start instruction, the CPU 201 of the robot vacuum cleaner executes specific processing (cleaning processing) using the setting content. The robot vacuum cleaner has an immediate execution button. As this button is pressed, the CPU 201 of the robot vacuum cleaner executes the specific processing (cleaning processing) with default settings without waiting for the cleaning start instruction from the smartphone. The immediate execution button may be a soft key or a hard key, or may be both a soft key and a hard key.

In this way, settings that are difficult to display on an operation screen provided in a robot vacuum cleaner main body can be configured on a screen of the information terminal 100 such as a smartphone, thus improving the usability for the user. Specifically, even in a case of using a robot as the processing apparatus 200, the present disclosure can improve the usability in the same way as in the case of using the MFP as the processing apparatus 200.

### <<Others>>

Note that the various controls described above as being performed by the CPU 101 or the CPU 201 may be performed by a single piece of hardware, or the entire apparatus may be controlled by a plurality of pieces of hardware (for example, a plurality of processors or circuits) sharing the processing. For example, at least part of the CPU 201 functioning as a reception unit (first reception unit), a control unit, a processing unit, a setting reception unit, a display control unit, and the like may be configured by hardware. Alternatively, at least part of the CPU 101 functioning as a display control unit, a second reception unit, a transmission unit, and the like may be configured by hardware.

While the present disclosure has been described in detail based on preferred embodiments, the present disclosure is not limited to these specific embodiments, and various embodiments within the spirit and scope of the present disclosure are also encompassed in the present disclosure. Furthermore, each of the above-described embodiments merely represents an embodiment of the present disclosure, and the respective embodiments may be combined as appropriate.

While the above embodiments have been described using examples where the processing apparatus 200 is applied to an MFP, a camera, and a robot vacuum cleaner, the present disclosure is not limited to these examples. The present disclosure is widely applicable to apparatuses having processing (functions) with changeable settings as the processing apparatus 200. The present disclosure is useful in a case where the display screen of the display unit 205 included in the processing apparatus 200 is smaller than the display screen of the display unit 105 included in the information terminal 100 that displays the setting screen for the processing apparatus 200. Alternatively, the present disclosure is useful in a case where the processing apparatus 200 is an image input/output apparatus having processing (functions) handling images. Specific examples of the applicable processing apparatus 200 in the present disclosure include the above-mentioned MFP, camera, and robot vacuum cleaner, as well as the following apparatuses (electronic devices): air conditioner, heating appliance, washing machine, refrigerator, dryer, rice cooker, lighting appliance, beauty appliance, and health appliance; imaging device, recording and reproduction apparatus, projector, audio device, security camera, drive recorder, and navigation device; or personal computer, PDA, mobile phone, portable image viewer, printer with a display, digital photo frame, music player, game console, and e-book reader.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to an aspect of the present disclosure, the usability regarding the settings can be improved.

This application claims the benefit of Japanese Patent Application No. 2024-224131, filed Dec. 19, 2024, which is hereby incorporated by reference herein in its entirety.

What is claimed is:

1. A processing apparatus, comprising:
at least one memory and at least one processor which functions as:
a reception unit configured to receive a first operation for executing specific processing;
a control unit configured to transmit an instruction to display a setting screen related to the specific processing to an information terminal, based on the receipt of the first operation, and to perform control to receive a setting content set on the setting screen from the information terminal; and
a processing unit configured to perform the specific processing using the received setting content.

2. The processing apparatus according to claim 1, wherein the number of setting items provided on the setting screen is greater than the number of setting items that can be set for the specific processing by an operation unit of the processing apparatus.

3. The processing apparatus according to claim 1, wherein the setting screen includes setting items different from setting items that can be set for the specific processing by an operation unit of the processing apparatus.

4. The processing apparatus according to claim 1, wherein the setting screen includes setting items that cannot be set by an operation unit of the processing apparatus.

5. The processing apparatus according to claim 1, wherein the specific processing is scan processing for scanning a document.

6. The processing apparatus according to claim 1, further comprising:
a setting reception unit configured to receive a setting as to whether to display the setting screen on the information terminal, wherein
if the setting received by the setting reception unit causes the information terminal not to display the setting screen, the control unit does not transmit an instruction to display the setting screen to the information terminal, and the processing unit performs the specific processing without changing the setting.

7. The processing apparatus according to claim 6, wherein
if the setting received by the setting reception unit causes the information terminal not to display the setting screen, the control unit does not transmit an instruction to display the setting screen to the information terminal, but transmits an event for performing the specific processing to the information terminal.

8. The processing apparatus according to claim 1, further comprising:
a display control unit configured to perform control to display a guide screen on a display unit of the processing apparatus, for prompting to perform a setting change operation by the information terminal, based on the receipt of the first operation.

9. The processing apparatus according to claim 8, wherein
the guide screen displays an operation item, and
in response to an operation on the operation item, the control unit performs control to transmit an instruction to close the setting screen to the information terminal.

10. The processing apparatus according to claim 8, wherein if a certain period of time has passed since the display of the guide screen, the processing unit performs the specific processing without changing the setting.

11. The processing apparatus according to claim 8, wherein if a certain period of time has passed since the display of the guide screen, the processing unit issues a warning; and then, if a further period of time has passed since the warning, the processing unit performs the specific processing without changing the setting.

12. The processing apparatus according to claim 1, wherein the processing unit performs the specific processing without changing the setting, upon receiving a second operation after an instruction to display the setting screen is transmitted.

13. The processing apparatus according to claim 12, wherein the second operation is long-pressing of a button capable of receiving the first operation.

14. The processing apparatus according to claim 12, wherein the second operation is double-clicking of a button capable of receiving the first operation.

15. The processing apparatus according to claim 6, wherein the information terminal is also capable of setting whether to display the setting screen in the information terminal.

16. A processing system in which an information terminal and a processing apparatus are connected through a network, wherein
the processing apparatus includes
a first reception unit configured to receive a first operation for executing specific processing,
a control unit configured to transmit an instruction to display a setting screen related to the specific processing to an information terminal, based on the receipt of the first operation, and to perform control to receive a setting content set on the setting screen from the information terminal, and
a processing unit configured to perform the specific processing using the received setting content, wherein
the information terminal includes
a display control unit configured to perform control to display the setting screen, based on the receipt of the instruction from the processing apparatus,
a second reception unit configured to receive a setting change operation related to the specific processing on the setting screen, and
a transmission unit configured to transmit a setting content set on the setting screen based on the setting change operation received by the second reception unit to the processing apparatus.

17. A processing method executed by a processing apparatus, comprising the steps of:
receiving a first operation for executing specific processing;
transmitting an instruction to display a setting screen related to the specific processing to an information terminal, based on the receipt of the first operation, and receiving a setting content set on the setting screen from the information terminal; and
performing the specific processing using the received setting content.

18. A non-transitory computer readable storage medium storing a program for causing a computer to perform a method, the method comprising the steps of:
receiving a first operation for executing specific processing;
transmitting an instruction to an information terminal to display a setting screen related to the specific processing, based on the receipt of the first operation, and receiving a setting content set on the setting screen from the information terminal; and
performing the specific processing using the received setting content.
